(19) United States
(12) Patent Application Publication
(10) Pub. No.: US 2005/0141623 A1
(43) Pub. Date: Jun. 30, 2005

(54) Transport stream transmission apparatus

(76) Inventors: Jae-Hun Cho, Suwon-si (KR); Sang-Ho Kim, Suwon-si (KR); Chan-Yul Kim, Bucheon-si (KR); Jun-Ho Koh, Suwon-si (KR); Yun-Je Oh, Yongin-si (KR)

Correspondence Address: CHA & REITER, LLC, 210 ROUTE 4 EAST STE 103, PARAMUS, NJ, 07652, US

(21) Appl. No.: 10/862,610

(22) Filed: Jun. 7, 2004

(30) Foreign Application Priority Data
Dec. 31, 2003 (KR) 2003-101711

(51) Int. Cl. H04N 7/12

(52) U.S. Cl. 375/240.28; 375/240.26

(57) ABSTRACT

Disclosed is a transport stream transmission apparatus, for example an MPEG Motion Picture Experts Group)—transport stream transmission apparatus. The transmission apparatus comprising a transmitter including a first media independent interface to generate a data stream, the data stream having a preamble and at least one transport stream, and a first physical layer device to receive a data frame from the first media independent interface, a back plane board to receive the data frame from the transmitter, and enable distribution of the received data frame to individual subscribers, and a second media independent interface to receive at least one transport stream from the second physical layer device, and enable individual subscribers to received transport stream, wherein the second media independent interface includes a second physical layer device to identify a preamble of the data frame received from the back plane board, perform a clock recovery operation, and generate at least one transport stream of the data frame.

### CLAIM OF PRIORITY

This application claims priority to an application entitled “MPEG-TS TRANSMISSION APPARATUS,” filed in the Korean Intellectual Property Office on Dec. 31, 2003 and assigned Serial No. 2003-101711, the contents of which are hereby incorporated by reference.

### BACKGROUND OF THE INVENTION

1. Field of the Invention

The present invention relates to a transmitter, and more particularly to a transmission apparatus for transmitting a transport stream (TS), for example a multi-channel Motion Picture Experts Group (MPEG)-TS, which is applied to a subscriber through a back plane.

2. Description of the Related Art

A conventional analog broadcast system has a number of disadvantages, for example, image quality deterioration caused by noise and ghost factors, ineffective use of broadcast frequency resources, and the unavailability of integrated data service, etc. With increasing customer demand for implementing high-quality images, digital broadcast technology has been rapidly increased. A digital broadcast system transmits broadcast data, using, for example, an MPEG-2 TS. The most important advantage acquired when broadcast data is converted into digital broadcast data is the ability to transmit much more channel-broadcast data over a conventional medium.

Many developers have conducted intensive research into techniques for extending/accommodating a multi-channel transmitted from a service provider to a subscriber. This follows the current trend of rapidly growing demands for Fiber To The Home (FTTH) technology. Moreover, FTTH acts as one of a variety of broadcast communication integration technologies each composed of a digital broadcast technique and a digital communication technique. The FTTH technology extends the range of optical cables. This range extension applies even to a home of a subscriber who resides in a residential district, installs optical equipment in the subscriber's home, and configures/satisfies communication lines needed for the subscriber's home. Thus, it can provide the fundamental knowledge for completely unifying a variety of independent communication elements, for example, a public telecommunication network, a computer communication service, a broadcast communication network, and a broadcast communication service, etc. FTTH technology can be established if the last coaxial cable connected to the subscriber's home network is configured in the form of an optical fiber A variety of broadcast data is configured in the form of an MPEG-TS, for example, HDTV (High Definition Television) broadcast data, and Terrestrial broadcast data, etc., are provided to individual subscribers using the aforementioned FTTH technology. FIG. 1 is a block diagram of a broadcast transmission system, particularly, a detailed block diagram of a Passive Optical Network (PON).

Referring to FIG. 1, the PON system has a Point-To-Multipoint access structure where a plurality of Optical Network Units (ONUs) 16 are shared with an Optical Line Termination (OLT) 14 via one optical fiber. The Program Provider (PP) 12 is an enterprise for providing CATV enterprises with a variety of broadcast programs. It can provide them with programs in channel units over a communication satellite. The PP 12 can provide the CATV enterprises with a variety of broadcast programs, for example, Video On Demand (VOD) broadcast data, public broadcast data, and satellite broadcast data, etc. The OLT 14 performs electric-to-optical conversion of digital broadcast data received from the broadcast enterprise. It provides a digital broadcast service over the PON, binds the electric-to-optical conversion data in a single optical signal, and transmits the single optical signal to the ONU 16. In this manner the ONU 16 transmits information received from the OLT 14 to a subscriber.

For example, the ONU 16 may transmit a clock signal and MPEG data to a variety of levels such as a Transistor-Transistor Logic (TTL), a Pseudo Emitter Coupled Logic (PCEL), and a Low Voltage Differential Signal (LVDS) over individual paths connected to subscribers. Accordingly, it transmits MPEG streams. FIG. 2 is a block diagram of a conventional MPEG-TS transmitter.

Referring to FIG. 2, the conventional MPEG-TS transmitter includes level translators 20 and 40 and a back plane board 30. The level translators 20 and 40 convert a transmission signal level into TTL, PCEL, and LVDS levels. The back plane board 30 distributes multi-channel MPEG-TS data and an MPEG-TS clock received from the level translator 20 to individual subscribers over a plurality of paths 32 and 34. The level translator 40 transmits the MPEG-TS data and the MPEG-TS clock distributed by the back plane board 30 to individual subscribers. In this case, the MPEG-TS data and the MPEG-TS clock are distributed to individual subscribers using the level translator 40. The lines 32 and 34 for distributing the MPEG-TS data and the MPEG-TS clock are configured in the form of differential lines to reduce the influence of noise or interference.

The MPEG stream transmission system shown in FIG. 1 requires two lines for transmitting the MPEG-TS data to individual subscribers and two lines for transmitting the MPEG-TS clock to individual subscribers. Accordingly, the back plane board contained in the ONU 16 can accommodate N MPEG streams in the MPEG stream transmission system of FIG. 1. Furthermore, 4N data lines must be routed to the back plane board 30 contained in the ONU 16. Therefore, the data transmission operation in the back plane board 30 is affected by the length and topology of the transmission path. The back plane board 30 occupies a limited area, therefore, it is difficult to perform a data routing operation and extend the MPEG stream.

Methods have been proposed to solve the above problem indicative of transmission path complexity in the back plane board of the ONU 16. One method includes controlling a Clock and Data Recovery (CDR) device to reconstruct data and clock upon receipt of MPEG data. Thus, the CDR device controls a transmission end to transmit only MPEG data and controls a reception end to perform a clock and data recovery operation.

FIG. 3 is a block diagram of an MPEG-TS transmitter with the CDR device. Referring to FIG. 3, the MPEG-TS data signal and the MPEG-TS clock signal are scrambled by the scrambler 50 in the transmission end, resulting in one MPEG data signal. This MPEG data signal is transmitted to the back plane board 60 of the ONU.

The back plane board 60 distributes the MPEG data to individual subscribers over a predetermined line 62. Line 62 (for distributing the MPEG data) is configured in the form of a differential line to reduce the influence of noise and interference. The MPEG data distributed from the back plane board 60 is transmitted to the CDR device 70. The CDR device 70 reconstructs the MPEG-TS data and the MPEG-TS clock. It also provides the descrambler 80 with the reconstructed MPEG-TS data and MPEG-TS clock. The descrambler 80 can descramble the scrambled MPEG-TS data and MPEG-TS clock.

Therefore, the MPEG-TS transmitter of FIG. 3 has an advantage in that it requires only 2N data lines to accommodate N MPEG streams. However, the MPEG-TS transmitter of FIG. 3 may lose an appropriate synchronization time because the CDR device 70 mistakes a null packet for a DC component. Therefore, the transmission end must scramble the MPEG-TS data and the MPEG-TS clock and a reception end must descramble the scrambled MPEG-TS data and the scrambled MPEG-TS clock.

### SUMMARY OF THE INVENTION

Therefore, the present invention has been made to reduce or overcome the above limitations, One object of the present invention is to provide an transport stream (TS) transmitter, for example an MPEG-TS, which (1) accommodates a plurality of ports when there is a need for a back plane board to transmit a signal to command a subscriber-end ONU having an FTTH broadcast communication integration configuration to accommodate a plurality of MPEG streams, (2) serially transmit MPEG streams using a low-priced Ethernet physical layer (PHY) device, and (3) controls a reception end to recover MPEG data and clocks using a built-in PLL (Phase Locked Loop), such that it can solve the prior art routing problem of the back plane board and can transmit high-quality and low-priced MPEG streams.

In accordance with the principals of the present invention, transport stream transmission apparatus is provided, for example an MPEG (Motion Picture Experts Group)-TS (Transport Stream) transmission apparatus. The transmission apparatus comprising a transmitter including a first media independent interface to generate a data stream, the data stream having a preamble and at least one transport stream, and a first physical layer device to receive a data frame from the first media independent interface, a back plane board to receive the data frame from the transmitter, and enable distribution of the received data frame to individual subscribers, and a second media independent interface to receive at least one transport stream from the second physical layer device, and enable individual subscribers to received transport stream, wherein the second media independent interface includes a second physical layer device to identify a preamble of the data frame received from the back plane board, perform a clock recovery operation, and generate at least one transport stream of the data frame.

### BRIEF DESCRIPTION OF THE DRAWINGS

The present invention will be more clearly understood from the following detailed description taken in conjunction with the accompanying drawings, in which:

FIG. 1 is a PON block diagram of a conventional broadcast transmission system;

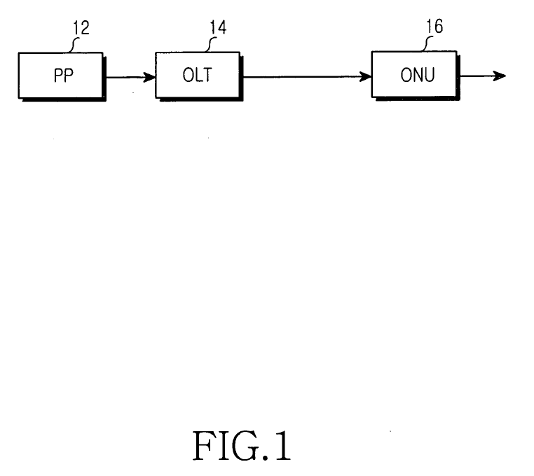

FIG. 2 is a block diagram of a conventional MPEG-TS transmitter;

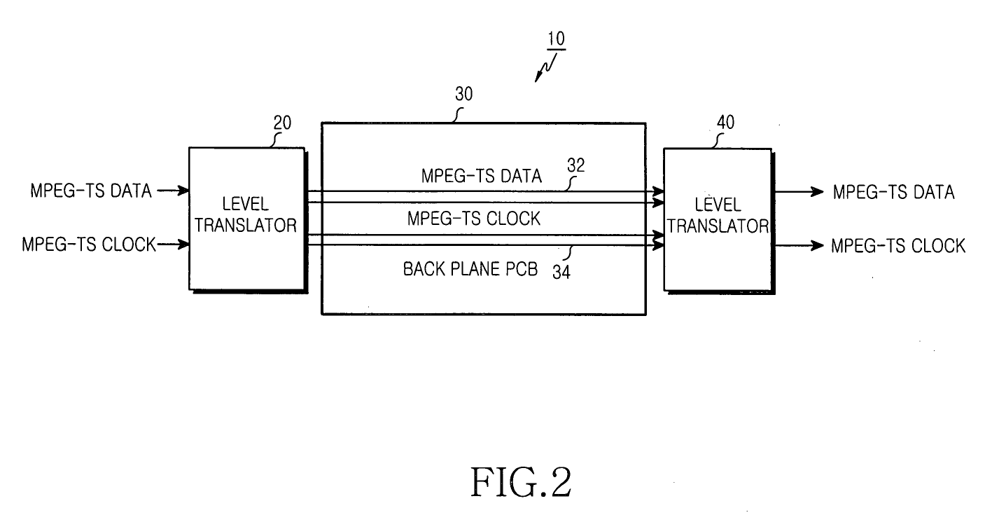

FIG. 3 is a block diagram of a conventional MPEG-TS transmitter having a CDR device;

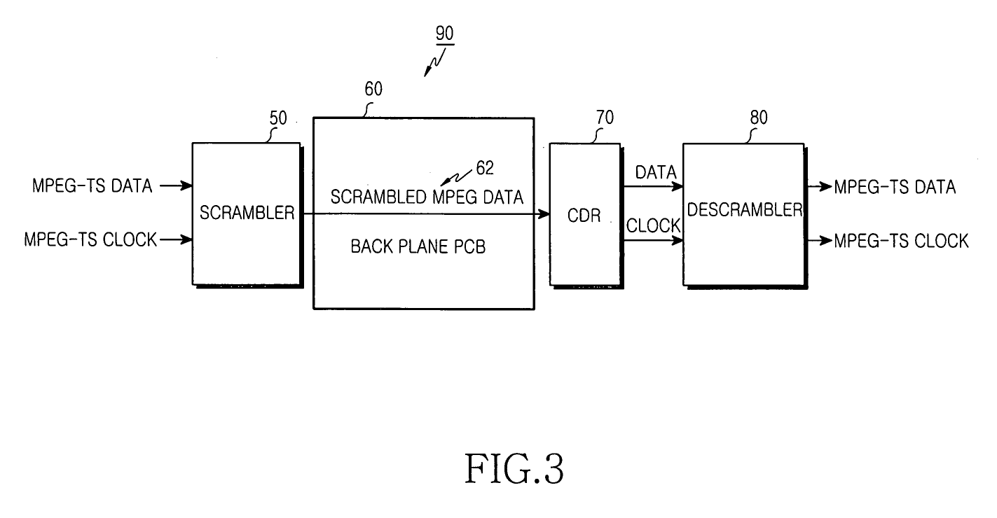

FIG. 4 is a block diagram an transport stream transmitter in accordance with a preferred embodiment of the present invention;

FIG. 5 illustrates a data frame in accordance with a preferred embodiment of the present invention; and

FIG. 6 illustrates the comparison result between the conventional back plane board and the inventive back plane board capable of reducing the number of transmission lines.

### DETAILED DESCRIPTION OF THE PREFERRED EMBODIMENTS

Now, embodiments of the present invention will be described in detail with reference to the annexed drawings. In the drawings, the same or similar elements are denoted by the same reference numerals even though they are depicted in different drawings. For the purposes of clarity and simplicity, a detailed description of known functions and configurations incorporated herein will be omitted as it may make the subject matter of the present invention unclear.

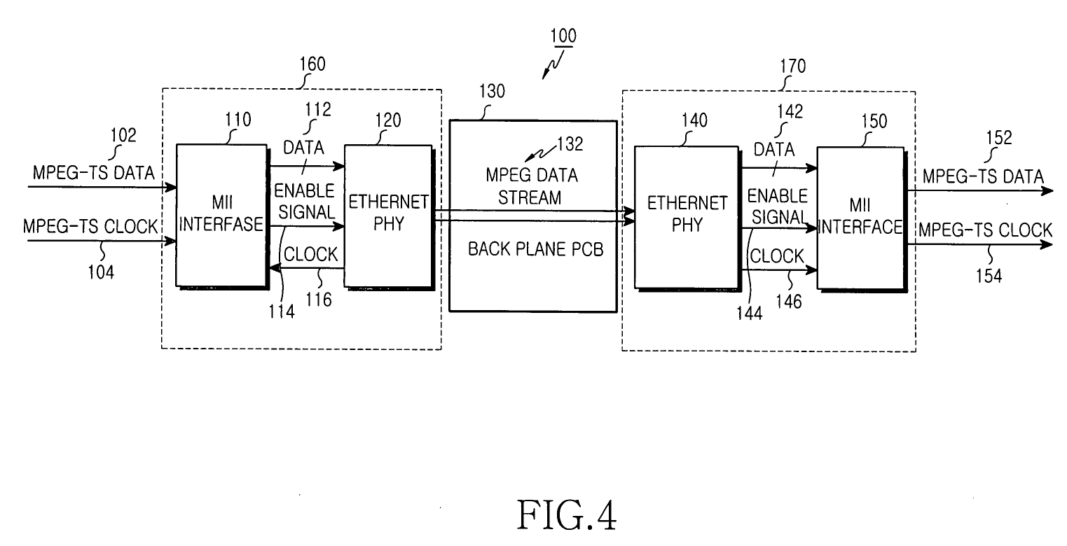

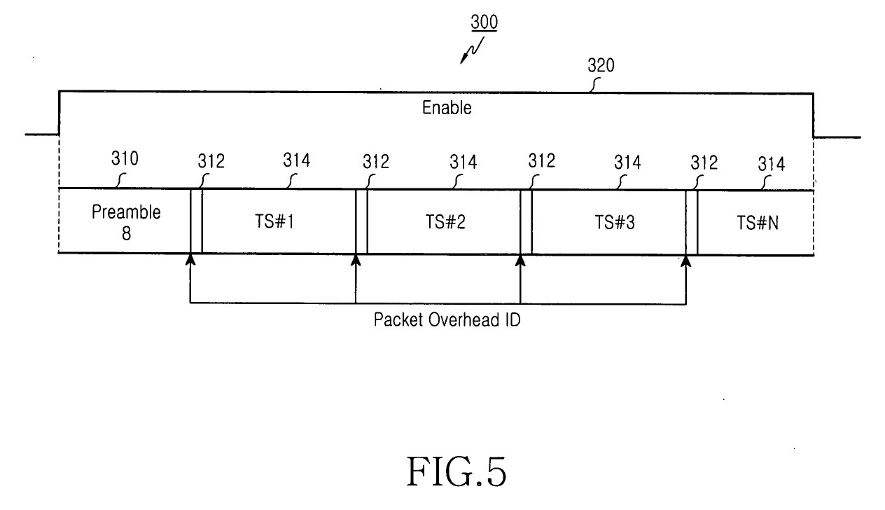

FIG. 4 is a block diagram of a transport stream transmitter, hereinafter referred to as an MPEG-TS transmitter for exemplary purposes, in accordance with a preferred embodiment of the present invention. FIG. 5 on illustrates a data frame in accordance with a preferred embodiment of the present invention.

Referring to FIG. 4, the MPEG-TS transmitter includes a transmitter 160, a back plane board 130, and a receiver 170. The transmitter 160 includes a transmission Media Independent Interface (MII) 110 and an Ethernet Physical layer (PHY) unit 120. The transmission MII 110 generates a data frame shown in FIG. 5, and transmits the data frame to the reception end. The data frame 300 includes a preamble 310 composed of 8 bytes, at least one MPEG-TS 314, and packet overhead ID information 312 of the MPEG-TS 314. The packet overhead ID 312 includes information associated with a subsequent MPEG-TS. The transmission MII 110 binds a preamble 310 of an MPEG-TS data frame and at least one MPEG-TS provided from a program provider, resulting in the creation of one MPEG-TS data frame. In this case, an area reserved for more than one MPEG-TS in the MPEG-TS data frame occupies the size 188 bytes long. Moreover, the MII 110 positions a plurality of MPEG-TSs at a predetermined processing part of an Media Access Control (MAC) layer other than the preamble 310 identified by the physical layer, resulting in a data frame configuration. In this case, the MPEG-TS data frame may include an MPEG-TS until a predetermined area reserved for the MPEG-TS is fully filled.

The transmission MII 110 provides a simple interconnection configuration between the MAC lower layer and the physical layer. The transmission MII 110 can carry out data communication between the MAC lower layer and the physical layer at a transfer rate of 10 Mb/sec˜100 Mb/sec. The transmission MII 10 can support a maximum transfer rate of 100 Mb/sec in the data transmission mode, and can also support a management function needed for the physical layer device 120. Furthermore, the transmission MII 10 may use other MIIs such as an RMII and an SMII, etc.

The MPEG-TS data transmitted from the transmission MII 110 to the data line 102 is configured in the form of a serial format to be fit for the transmission media 102. However, the MII standard specifies a parallel format having a predetermined bit width in terminals of the physical layer device 120. Therefore, the transmission MII 120 converts serial-format MPEG-TS data into a parallel-format data frame, and provides the physical layer device 120 with the parallel-format data frame. The MII 120 generates an enable signal 320 while transmitting the MPEG-TS data frame, and provides the physical layer device 120 with the enable signal 320.

The physical layer device 120 carries out a fiber transmission (FX) operation for an Ethernet frame transferred from the transmission MII 110. The FX operation supports a two-level Low Voltage Positive Emitter Coupled Logic (LVPECL). The physical layer device 120 may be one of 100BASE-FX, 1000BASE-SX, and 1000BASE-LX transceivers. The 100BASE-FX, 1000BASE-SX, and 1000BASE-LX transceivers each implement a plurality of ports in one chip, such that a plurality of MPEG-TS data streams may be accommodated in a single chip. In this way, the transmitter 160 transmits a two-level LVPECL serial MPEG-TS data frame to the back plane board 130 of the ONU. The MPEG-TS data frame of the back plane board 130 is transmitted to the receiver 170 via a transmission path 132.

The receiver 170 includes a reception MII 150 and an Ethernet physical layer (PHY) device 140. The receiver 170 receives the MPEG-TS data frame shown in FIG. 5. The receiver 170 transmits the MPEG-TS data frame to the Ethernet PHY device 140. The Ethernet PHY device 140 identifies the preamble 310 for synchronizing the MPEG-TS data frame, recovers a clock signal using a CDR (Clock and Data Recovery) device (not shown), and transmits the recovered clock signal to the reception MII 150.

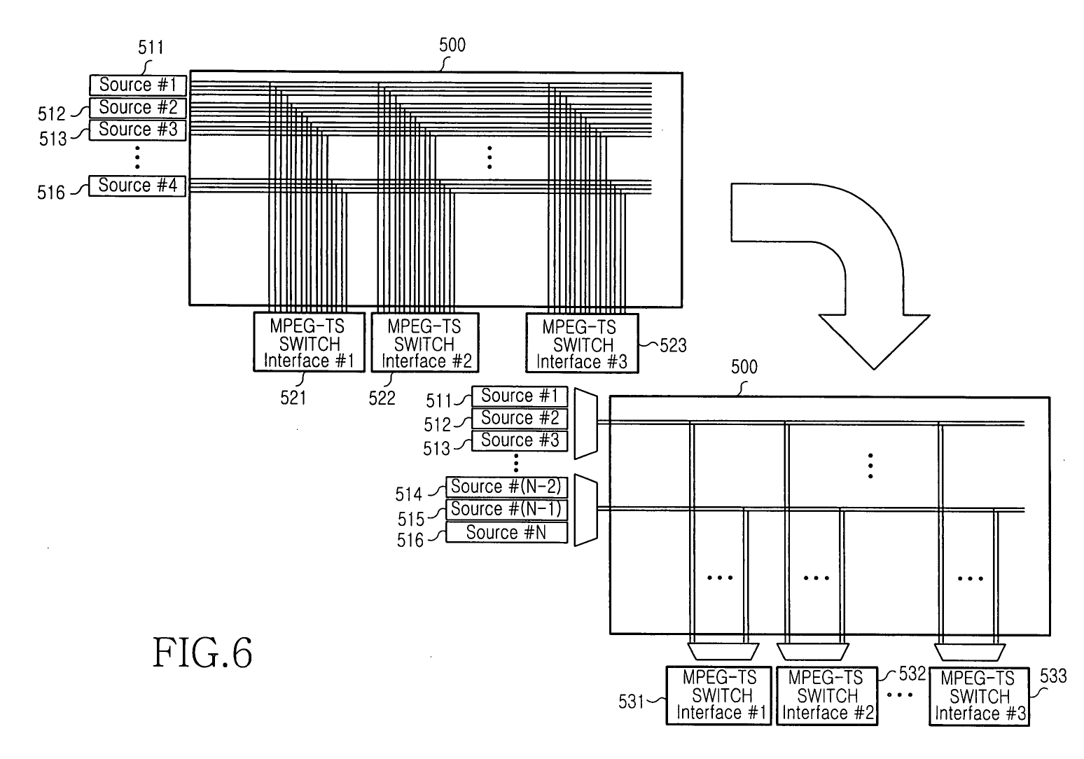

The Ethernet PHY device 140 converts at least one MPEG-TS data stream into a parallel-format MPEG-TS data stream, and transmits the parallel-format MPEG-TS data stream to the reception MII 150. The Ethernet PHY device 140 generates an enable signal 144. The enable signal 144 is generated when a data frame is received, and is then transmitted to the reception MII 150. Upon receiving the MPEG-TS data from the Ethernet PHY device 140, the reception MII 150 converts parallel-format data into serial-format data, and transmits the serial-format data to individual subscribers. A method for controlling the MPEG-TS transmitter to change the back plane configuration into another configuration will hereinafter be described with reference to FIG. 6.

FIG. 6 illustrates the comparison result between the conventional back plane board and the inventive back plane board capable of reducing the number of transmission lines. The conventional back plane board 500 is positioned at the upper-left end of FIG. 6. The conventional back plane board 500 receives individual MPEG-TS data and MPEG-TS clock from individual channel sources 512, 513, and 516 through a transmitter. The back plane board 500 is connected to not only two lines for distributing the MPEG-TS data to individual subscribers, but also the remaining two lines for distributing the MPEG-TS clock to the subscribers. As indicated above, the MII according to the present invention binds more than one MPEG-TS data to generate one MPEG-TS data frame, and transmits the generated MPEG-TS data frame. Therefore, the back plane board 500 positioned at the lower right end of FIG. 6 can transmit a plurality of MPEG-TSs over a single line. For example, more than one MPEG-TS data received from either sources 511, 512, and 513 or other sources 514, 515, and 516 can be transmitted to individual subscribers 531, 532, and 533 via a single transmission line.

Accordingly, an MPEG-TS transmitter according to the present invention adapts a commercial Ethernet PHY device to transmission and reception ends. Thus, it can transmit MPEG streams through a back plane board. Therefore, the MPEG-TS transmitter can remove a specific signal line needed for a clock signal from a transmission line located on the back plane board, such that it can guarantee a predetermined routing area on the back plane board. Furthermore, the MPEG-TS transmitter can enable the PHY device to accommodate a multi-channel MPEG-TS therein, and can also enable the PHY device to accommodate an MPEG-TS having variable capacity. When using a multi-port physical layer, the MPEG-TS transmitter processes a plurality of MPEG streams using only one chip. Thus, it effectively uses an area or space inside of the back plane board and has a lower production cost as compared to a dedicated back plane.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An transport stream transmission apparatus, comprising:
a transmitter including a first media independent interface to generate a data stream, the data stream having a preamble and at least one transport stream, and a first physical layer device to receive a data frame from the first media independent interface;
a back plane board to receive the data frame from the transmitter, and enable distribution of the received data frame to individual subscribers; and
a second media independent interface to receive at least one transport stream from the second physical layer device, and enable individual subscribers to received transport stream, wherein the second media independent interface includes a second physical layer device to identify a preamble of the data frame received from the back plane board, perform a clock recovery operation, and generate at least one transport stream of the data frame.

2. The apparatus as set forth in claim 1, wherein the transport stream is an MPEG transport stream.

3. The apparatus as set forth in claim 1, wherein the preamble and the at least one transport stream of the data stream are identified by a physical layer and media access control layer, respectively.

4. The apparatus as set forth in claim 1, wherein the first media independent interface further includes performing a fiber transmission operation.

5. The apparatus as set forth in claim 1, wherein the first and second physical layer devices are Ethernet physical layer devices.

6. The apparatus as set forth in claim 2, wherein the first media independent interface converts serial-format MPEG -transport stream data into a parallel-format MPEG transport stream data frame.

7. The apparatus as set forth in claim 2, wherein the second media independent interface, upon receiving at least one MPEG-transport stream from the second physical layer device, converts parallel-format data into serial-format data.

8. The apparatus as set forth in claim 2, wherein the MPEG-TS includes a preamble composed of 8 bytes, at least one MPEG-TS, and a packet overhead ID of the MPEG-TS.

9. The apparatus as set forth in claim 2, wherein the first media independent interface generates an enable signal while transmitting the MPEG-TS data frame, and transmits the enable signal to the first physical layer device.

10. The apparatus as set forth in claim 1, wherein the second physical layer device generates an enable signal while receiving the MPEG-TS data from the back plane board, and transmits the enable signal to the second media independent interface.
